(19) United States
(12) Patent Application Publication
(10) Pub. No.: US 2007/0209744 A1
(43) Pub. Date: Sep. 13, 2007

(54) Pneumatic Tire Containing Oxygen Absorbent

(75) Inventor: Tomoyuki Matsumura, Kanagawa (JP)

Correspondence Address: CONNOLLY BOVE LODGE & HUTZ LLP, 1875 EYE STREET, N.W., SUITE 1100, WASHINGTON, DC, 20036, US

(73) Assignee: The Yokohama Rubber Co., Ltd., Tokyo (JP)

(21) Appl. No.: 11/547,638

(22) PCT Filed: Apr. 5, 2005
(86) PCT No.: PCT/JP05/07001

§ 371 Date: Oct. 5, 2006

(30) Foreign Application Priority Data
Apr. 6, 2004 (JP) 2004-112164

(51) Int. Cl. B60C 5/14

(52) U.S. Cl. 152/510

(57) ABSTRACT

A pneumatic tire using a laminate of a layer of a rubber or thermoplastic resin composition containing an oxygen absorbent laminated with inner liner materials on both surfaces thereof, as a an inner liner, as a tie rubber, as a rubber member interposed between the edges of a tire structural material and the tire inside surface (i.e., the inner liner), or in the form of a sheet as a filler sheet between each edge of a tire structural material and an inner liner, whereby deterioration of the tire durability due to permeation of air filled inside the pneumatic tire into the inside of the tire can be prevented.

### TECHNICAL FIELD

The present invention relates to a pneumatic tire using a rubber and/or thermoplastic resin composition containing an oxygen absorbent, and, more specifically, relates to a pneumatic tire using, as a rubber member of the pneumatic tire, the rubber or thermoplastic resin composition containing an oxygen absorbent.

### BACKGROUND ART

Pneumatic tires are normally filled with air in the inside cavity thereof, and therefore, there has been the problem of the oxygen contained in the filled air permeating inside the tire-forming members and oxidatively attacking the tire parts with the elapse of time, whereby affecting the durability of the pneumatic tires is affected. Various studies have been made in the past to solve this problem. For example, it has been proposed to fill tires with nitrogen, instead of air (see Japanese Patent Publication (A) No. 10-250311), remove oxygen from the inside air (see Japanese Patent Publication (A) No. 2002-337507), and to provide a supplementary cord layer to enable the oxygen to escape (see Japanese Patent Publication (A) No. 2003-80905), but the filling of nitrogen would be expensive and place a burden on the user and entry of moisture from the outside would conversely cause the durability to deteriorate. These proposals are not yet practically used.

### DISCLOSURE OF THE INVENTION

Accordingly, the object of the present invention to eliminate the above-mentioned problems in the prior art and to prevent the air filled in a pneumatic tire from permeating to the inside of the tire-forming members to cause degradation of the rubber by oxygen and to reduce the durability of the tire.

In accordance with the present invention, there is provided a pneumatic tire using, as an inner liner, a laminate comprising a layer of a rubber and/or a thermoplastic resin composition containing an oxygen absorbent laminated with inner liner materials on both surfaces thereof.

In accordance with the present invention, there is further provided a pneumatic tire using a rubber and/or thermoplastic resin composition containing an oxygen absorbent, as a tie rubber. Preferably, it is comprised of a rubber composition containing an oxygen absorbent at the part of the tie rubber in a range of 10 mm or more, preferably 20 to 30 mm from the belt edge.

In accordance with the present invention, there is further provided a pneumatic tire using a rubber and/or thermoplastic resin composition containing an oxygen absorbent, as a rubber member interposed between the edge of a tire structural material and the tire inside surface (i.e., inner liner). As the rubber member, for example, a belt cord rubber, belt edge tape (BET), belt edge cushion (BEC), L filler, etc. may be mentioned.

In accordance with the present invention, there is provided a pneumatic tire comprising a rubber and/or thermoplastic resin composition containing an oxygen absorbent in the form of a sheet arranged, as a filling sheet between the edge of a tire structural material and an inner liner. Preferably the sheet of the rubber or thermoplastic resin composition is arranged between an inner liner of a shoulder portion and a carcass, between a carcass and a carcass or between a carcass and a belt.

In accordance with the present invention, by using, as a member of a pneumatic tire, a rubber and/or thermoplastic resin composition containing an oxygen absorbent, it is possible to prevent oxygen degradation of the rubber member and to improve the durability of the pneumatic tire.

### BRIEF DESCRIPTION OF THE DRAWINGS

FIG. 1 is a semi-cross-sectional explanatory view along the meridian of an example of a pneumatic tire according to the present invention.

### BEST MODE FOR CARRYING OUT THE INVENTION

The singular form expressions used in the present description and the attached claims include the plural forms, except when otherwise clear from the context.

The inventors made various attempts to solve the above problem and to prevent degradation of rubber members due to oxygen by using a rubber and/or thermoplastic resin composition containing an oxygen absorbent. When the rubber and/or thermoplastic resin composition is used in the innermost surface of a tire (i.e., inner liner), the oxygen absorbent is reacted with oxygen, during storage of the tire, and therefore, a sufficient effect cannot be expected at the time of use after assembly on the rim. Therefore, according to the present invention, the rubber and/or thermoplastic resin composition containing the oxygen absorbent is used in the condition sandwiched between ordinary inner liner materials, so as to trap oxygen, which does not permeate under ordinary atmospheric pressure, but permeate through the inner liner materials under the pressurized state. Note that there is no effect, of course, even if arranging the composition outside (for example, near the belt edge, near the carcass turnup edge, etc.) from the parts having an effect on tire durability.

In another embodiment of the present invention, it is possible to compound an oxygen absorbent into other members of the pneumatic tire (e.g., tie rubber, belt cord rubber, L filler, BET, BEC, additional filling sheet, etc.) to absorb the oxygen permeating from the inside surface of the tire and to prevent degradation of the rubber (of the belt edge, etc.) In particular, the decrease in the physical properties due to permeation of oxygen from the inside of the tire has a great effect on the tire durability near the edges of the tire members. According to the present invention, the rubber and/or thermoplastic resin composition containing an oxygen absorbent is used as a rubber member at the inside of the tire, for example, near the belt edge.

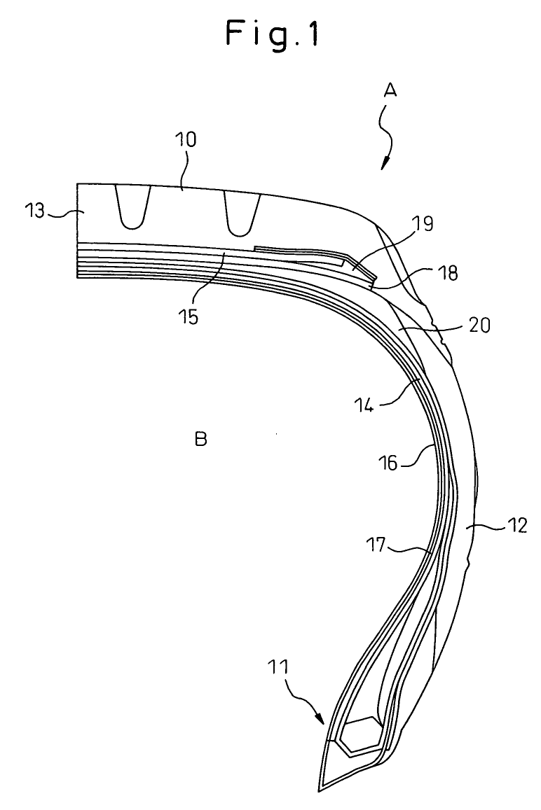

The configuration of the present invention will now be explained, while referring to the drawing. FIG. 1 is a semi-cross-sectional explanatory view along the meridian of an example of a typical conventional pneumatic tire.

In FIG. 1, a pneumatic tire A is, as conventionally, composed of a pair of left and right beads 11 and 11, a pair of left and right sidewalls 12 and 12 connected to these beads 11 and 11, and a tread 13 arranged between the above sidewalls 12 and 12. Between the pair of left and right beads 11 and 11, a carcass layer 14 of a single layer or multiple layers of two layers or more is provided. At the tread portion 13, a belt layer 15 is arranged so as to surround the outer circumference thereof. Reference numeral 10 is a tread surface, 16 is an inner liner layer, and 17 is a tie rubber.

In the present invention, it is possible to use, as the inner liner, a laminate composed of a layer of a rubber and/or thermoplastic resin composition as explained below, into which an oxygen absorbent has been incorporated and which is sandwiched with inner liner materials. As such inner liner materials, as described in Japanese Patent Publication (A) No. 8-259741, a material having a melting point of 80° C. or more, preferably 100° C. or more, an air permeation amount of 25×10⁻¹² cc·cm/cm²·sec·cmHg or less, preferably 0.05×10⁻¹² to 10×10⁻¹² cc·cm/cm²·sec·cmHg, and a Young's modulus of 1 to 500 MPa, preferably 10 to 300 MPa is preferably used. As such materials, there are those described in Japanese Patent Publication (A) No. 8-259741. Giving a specific preferable example, a material composed of a resin layer forming a continuous layer, into which 10% by weight or more of a polyamide-based resin is blended and into which 10% by weight of a butyl rubber is finely dispersed, is used as the inner liner material.

The laminate forming the inner liner used in the preferred embodiment of the present invention is divided into three layers, of which only the intermediate layer contains the oxygen absorbent. By making the formulation the same other than the oxygen absorbent, there is no change in physical properties at the interfaces and no detrimental effect on the bondability. More preferably, when not using a thermoplastic resin composition for the inner liner, but using an inner liner using an ordinary butyl-based rubber, the thicknesses of the three layers become:

Tire inside surface side: 0.1 mm or more, more preferably 0.3 mm or more,

Intermediate layer (containing absorbent): 0.4 mm or more, more preferably 0.6 mm or more, and

Carcass side: 0.1 mm or more.

The inside surface side of the tire has to prevent any reaction between the oxygen absorbent and oxygen (air), when molding the tire and when storing the finished tire (before rim assembly and filling air), while the carcass side need only be of a thickness capable of preventing the reaction between the oxygen absorbent and oxygen (air) at the time of tire molding.

The intermediate layer provides the remaining thickness. The thicker intermediate layer is better, while securing the overall thickness required for the inner liner.

When using a thermoplastic resin composition for the inner liner, preferably the thicknesses of the three layers are as follows, when designating the total thickness of the inner liner as A:

Tire inside surface side: 0.08A or more, more preferably 0.25A or more

Intermediate layer (containing the oxygen absorbent): 0.33A or more, more preferably 0.50A or more Carcass side: 0.08A or more Further, when simultaneously extruding (coextruding) the inner liner and tie rubber for production, the tire inside surface side and the intermediate layer may have the formulations generally used as the inner liner rubber and the carcass side is made the tie rubber to thereby form the three layer structure.

In the present invention, by using a rubber and/or thermoplastic resin composition containing an oxygen absorbent for the rubber parts (e.g., tie rubber, carcass coat rubber, BEC, L filler, bead filler, belt cord rubber, BET) interposed between the carcass edge, belt edge, or edges of other structural members and the inner liner of the inside surface of the pneumatic tire A having the above basic structure, the oxygen permeating from the tire inside cavity B to the insides of the tire-forming members with the lapse of time is absorbed and trapped, and therefore, it is possible to efficiently prevent the rubber of the edges of the tire-forming members from being degraded by oxidation.

When a sheet shaped oxygen absorbent-containing layer in the form of a sheet is arranged between the inner liner and the edges, preferably the oxygen absorbent is compounded into a 0.2 mm to 1 mm thick sheet of rubber or thermoplastic resin and this is arranged between a location of a maximum of at least 25% of the belt width from the belt edge to the inside (i.e., equator direction) and the bead core. Further, more preferably the formulation other than the oxygen absorbent is made the same as that of a member at the inside when such a sheet is arranged (if between the carcass and belt, the carcass coat rubber, while if between the carcass and tie rubber, the tie rubber).

As the rubber compounded into the rubber and/or thermoplastic resin composition used in the present invention, the various types of natural rubber (NR), various types of polyisoprene rubber (IR), various types of polybutadiene rubber (BR), various types of styrene-butadiene copolymer rubber (SBR), various types of butyl rubber (IIR), various types of halogenated butyl rubber, various types of ethylene-propylene-diene copolymers (EPDM), and other diene-based rubber and other rubber capable of using for tire applications may be mentioned. These may be used alone or in any blends thereof.

The thermoplastic resin compounded into the rubber and/or thermoplastic composition used in the present invention may be made any thermoplastic resin capable of using for tire applications, specifically, polyamide-based resins (for example, Nylon 6 (N6), Nylon 66 (N66), Nylon 46 (N46), Nylon 11 (N11), Nylon 12 (N12), Nylon 610 (N610), Nylon 612 (N612), Nylon 6/66 copolymer (N6/66), Nylon 6/66/610 copolymer (N6/66/610), Nylon MXD6 (MXD6), Nylon 6T, Nylon 6/6T copolymer, Nylon 66/PP copolymer, Nylon 66/PPS copolymer), polyester-based resins (for example, polybutylene terephthalate (PBT), polyethylene terephthalate (PET), polyethylene isophthalate (PEI), PET/PEI copolymer, polyarylate (PAR), polybutylene naphthalate (PBN), liquid crystal polyester, polyoxyalkylene diimidic acid/polybutyrate terephthalate copolymer, or another aromatic polyester), polynitrile-based resins (for example, polyacrylonitrile (PAN), polymethacrylonitrile, acrylonitrile/styrene copolymer (AS), methacrylonitrile/styrene copolymer, methacrylonitrile/styrene/butadiene copolymer), polymethacrylate-based resins (for example, polymethyl methacrylate (PMMA), polyethyl methacrylate), polyvinyl-based resins (for example, vinyl acetate (EVA), polyvinyl alcohol (PVA), vinyl alcohol/ethylene copolymer (EVOH), polyvinylidene chloride (PVDC), polyvinyl chloride (PVC), vinyl chloride/vinylidene chloride copolymer, vinylidene chloride /methylacrylate copolymer), cellulose-based resins (for example, cellulose acetate, cellulose acrylate butyrate), fluorine-based resins (for example, polyvinylidene fluoride (PVDF), polyvinyl fluoride (PVF), polyfluorofluoroethylene (PCTFE), tetrafluoroethylene/ethylene copolymer (ETFE)), imide-based resins (for example, aromatic polyimide (PI)), etc. may be mentioned.

The rubber and/or thermoplastic resin composition usable in the present invention may be a thermoplastic elastomer composition having the above-mentioned rubber as an elastomer component, having a polyamide-based resin or other above thermoplastic resins as a resin component, using the resin component as a continuous phase (matrix), and dispersing therein a diene-based rubber or other elastomer component. Further, the elastomer composition is preferably used in a dynamically vulcanized state (more specifically, see Japanese Patent Publication (A) No. 8-259741). That is, for example, the thermoplastic resin component and elastomer component (in the case of rubber, unvulcanized) are melt mixed in advance by a twin-screw extruder etc. to cause the elastomer component to disperse, as a dispersed phase (domain), in the thermoplastic resin forming the continuous phase (matrix phase). At that time, the vulcanization agent is added, while mixing to dynamically cause the elastomer component to be vulcanized. Note that, at this time, various types of compounding agents (except for the vulcanization agent) may be added to the thermoplastic resin or elastomer component during the mixing, but these may also be mixed thereinto, in advance before the mixing.

The rubber or thermoplastic resin composition used in the present invention may further be a composition composed of 100 parts by weight of an ethylenic unsaturated nitrile-conjugated diene-based copolymer (HNBR) having a content of conjugated diene units of 30% by weight or more, preferably 20% by weight or more, and 20 to 120 parts by weight of a metal salt of an ethylenic unsaturated carboxylic acid, preferably 25 to 100 parts by weight. If the content of the conjugated diene units is more than 30% by weight, that is, if the partial hydrogenation rate is about 50% or less, the rubber composition will become insufficient in strength, and therefore, this is not preferable. As an ethylenic unsaturated nitrile-conjugated diene-based copolymer (HNBR), for example, the above hydrogenated NBR is already well known. Copolymers of acrylonitrile, methacrylonitrile, or other ethylenic unsaturated nitriles and 1,3-butadiene, isoprene, 1,3-pentadiene, or other conjugated diene and copolymers with monomers capable of copolymerizing with the above two types of monomers, for example, vinyl aromatic compounds (meth)acrylic acid, alkyl(meth)acrylate, alkoxyalkyl(meth)acrylate, cyanoalkyl(meth)acrylate, etc., specifically acrylonitrile-butadiene copolymer rubber, acrylonitrile-isoprene copolymer rubber, acrylonitrile-butadiene-isoprene copolymer rubber, acrylonitrile-butadiene-acrylate copolymer rubber, acrylonitrile-butadiene-acrylate-methacrylic acid copolymer rubber, etc. may be mentioned. These rubber contain 30 to 60% by weight of ethylenic unsaturated nitrile units and have conjugated diene units reduced by partial hydrogenation or other means to 30% by weight or less, preferably 20% by weight or less, of conjugated diene units. If the amount of the metal salt of the ethylenic unsaturated carboxylic acid (for example, zinc dimethacrylate, magnesium dimethacrylate, zinc diacrylate, and magnesium diacrylate may be mentioned) compounded in the HNBR is too small, the rubber becomes insufficient in strength, and therefore, this is not preferable, while conversely if too large, the rubber becomes hard and the processability becomes poor, and therefore, this is not preferable, either. Note that the rubber or thermoplastic resin composition is described in detail in Japanese Patent Publication (A) No. 1-306440. For example, such a composition is commercially available as the composite from Nippon Zeon in the “ZSC” (trademark) series, for example ZSC2295, ZSC2295N, ZSC2395, and ZSC2298. These commercially available products may be used in the present invention.

The oxygen absorbent capable of using in the present invention may be any oxygen absorbent having the ability to trap oxygen in the air. Specifically, an iron powder oxygen absorbent utilizing the oxidation reaction of iron powder to absorb the oxygen in the air may be mentioned. Usually, a combination of 100 parts by weight of iron powder having a surface area of 0.5 m²/g or more and 0.1 to 50 parts by weight of a metal halide, for example, sodium chloride, sodium bromide, calcium chloride, magnesium chloride, or other halides of an halogen such as chlorine, bromine, iodine, with an alkali metal or alkali earth metal is used. These may be simply mixed. Alternatively, the surface of the iron powder may be coated with a metal halide. Note that the oxygen absorbent used in the present invention may further be combined with zeolite or other porous particles impregnated with moisture so as to further promote oxidation of the iron by the oxygen.

The amount of the oxygen absorbent compounded into the rubber or thermoplastic resin according to the present invention is not particularly limited, but compounding 5 to 35 parts by weight of the oxygen absorbent based upon 100 parts by weight of the rubber or thermoplastic resin is preferable, compounding 7 to 20 parts by weight is more preferable. If the amount of the oxygen absorbent compounded is too small, the desired oxygen absorption effect is liable to become hard to obtain, while if the amount compounded is too large, the elongation is liable to be decreased and other physical properties to be declined, and therefore, these are not preferable.

The rubber or thermoplastic resin composition according to the present invention may contain, in addition to the above-mentioned oxygen absorbent, various types of additives capable of using in rubber or thermoplastic resin compositions, in particular rubber or thermoplastic resin compositions for tires, such as carbon black, silica, or other fillers, a vulcanization or cross-linking agent, a vulcanization or cross-linking accelerator, various types of softening agents (for example, oils), an antioxidant, a plasticizer, etc. The additives may be mixed and vulcanized by general methods to obtain compositions for use for vulcanization or cross-linking. The compounding amounts of these additives may be made the conventional general amounts insofar as the object of the present invention is not contravened.

### EXAMPLES

Examples will now be used to further explain the present invention, but the scope of the present invention is of course not limited to these Examples.

### Examples 1 to 5 and Comparative Examples 1 to 3

Using Ageless (tradename: iron-powder-based oxygen absorbent) made by Mitsubishi Gas Chemical as the oxygen absorbent, the following Comparative Experiments were carried out.

That is, as Comparative Examples 1 to 3, a tire having a butyl rubber inner liner layer (thickness 1.2 mm) used for a conventional general pneumatic tire and a tie rubber of a thickness of 0.8 mm (usually the same formulation as the carcass coat rubber) used for a conventional general pneumatic tire (Comparative Example 1); a tire coating the inside surface of the same inner liner layer (with no oxygen absorbent) with an oxygen absorbent composed of Ageless (tradename: iron-powder-based oxygen absorbent) made by Mitsubishi Gas Chemical to an amount of 0.01 g/m² (total of coated oxygen absorbent being two times amount coated of following Comparative Example 3) (Comparative Example 2); and a tire having a butyl rubber layer of a thickness of 1.2 mm used for a conventional general pneumatic tire and containing as an oxygen absorbent the above Ageless (tradename: iron-powder-based oxygen absorbent) made by Mitsubishi Gas Chemical in an amount of 10% by weight and a tie rubber layer having a thickness of 0.8 mm (usually the same formulation as the carcass coat rubber) used for a conventional a general pneumatic tire (Comparative Example 3) were tested.

On the other hand, as Examples 1 to 5 according to the present invention, a tire dividing a butyl rubber layer of a thickness of 1.2 mm used for a conventional general pneumatic tire into three layers in the thickness direction (0.4 mm each), compounding into the intermediate layer Ageless (tradename: iron-powder-based oxygen absorbent) made by Mitsubishi Gas Chemical in an amount of 30% by weight, and arranging a tie rubber layer having a thickness of 0.8 mm used for the tire (inner liner total including 10% by weight: total of oxygen absorbent being same as amount of Comparative Example 3) and a conventional general pneumatic (Example 1); a tire compounding into a butyl rubber layer having a thickness of 1.2 mm used for a conventional general pneumatic tire and a tie rubber layer having a thickness of 0.8 mm used for a conventional general pneumatic tire the above Ageless (tradename: iron-powder-based oxygen absorbent) made by Mitsubishi Gas Chemical in an amount of 10% by weight (the total of the oxygen absorbent compounded being smaller than the compounding amounts of Comparative Example 3 and Example 1) (Example 2); a tire compounding into the tie rubber layer in a range of 10 mm from the belt edge the above oxygen absorbent in an amount of 10 parts by weight (Example 3); a tire compounding into the belt edge cushion rubber the above oxygen absorbent in an amount of 10 parts by weight (Example 4); and a tire compounding into a 0.4 mm thick rubber sheet 10% by weight of the above oxygen absorbent and arranging this between two carcass layers 14 (that is, the outside of the innermost layer carcass of a carcass layer composed of a plurality of layers) in the range from a position 20 mm to the equator side from the belt edge to the bead (Example 5) were evaluated and tested as follows:

Method of Evaluation

The tires were evaluated by an indoor drum durability test under the following conditions:

Evaluated tire size: 195/85R16 114/112L (tire for small trucks)

Pretreatment: Standing and storage in a 90% oxygen atmosphere at room temperature and 70% relative humidity for 336 hours (14 days) in the state of the tire alone, then filling with 100% oxygen, assembly over the rims, and storage at an inside pressure of 350 kPa in a 90% oxygen atmosphere at room temperature and 70% relative humidity for 14 days.

Method for Evaluation of Durability: After the above pretreatment, the tire was evaluated, based on the method defined by JIS D4230. That is, it was assembled on the rim, then 1) filled with 100% oxygen (the standard calls for air) until the prescribed air pressure, then 2) run on under the prescribed conditions, while increasing the load by 8% and the speed by 5 km/h every 6 hours. The test was continued until the tire broke. The total distance run on until breakage and the end was expressed as an index shown in Table I. Note that the higher the index, the higher the durability indicated.

TABLE I

| | Evaluation of |
|---|---|
| Example No. | durability |
| Comp. Ex. 1 | 100 |
| Comp. Ex. 2 | 100 |
| Comp. Ex. 3 | 105 |
| Ex. 1 | 135 |
| Ex. 2 | 135 |
| Ex. 3 | 120 |
| Ex. 4 | 125 |
| Ex. 5 | 130 |

### INDUSTRIAL APPLICABILITY

As is clear from the results of the above experiments, according to the present invention, oxidative degradation of rubber due to permeation of the air filled inside the pneumatic tire to the tire members is effectively suppressed with an oxygen absorbent trapping the oxygen, and therefore, the pneumatic tire can be increased in durability and the tire life can be extended.

1. A pneumatic tire using, as an inner liner, a laminate comprising a layer of a rubber and/or a thermoplastic resin composition containing an oxygen absorbent laminated with inner liner materials on both surfaces thereof.

2. A pneumatic tire using, as a tie rubber, a rubber and/or thermoplastic resin composition containing an oxygen absorbent.

3. A pneumatic tire as claimed in claim 2, wherein a portion of the tie rubber in a range of 10 mm or more from the belt edge comprises a rubber composition containing an oxygen absorbent.

4. A pneumatic tire using a rubber and/or thermoplastic resin composition containing an oxygen absorbent, as a rubber member interposed between each edge of a tire structural material and the tire inside surface (that is, the inner liner).

5. A pneumatic tire as claimed in claim 4, wherein the oxygen absorbent is incorporated into a belt cord rubber, a belt edge tape (BET), a belt edge cushion (BEC) or an L filler.

6. A pneumatic tire comprising a rubber and/or thermoplastic resin composition containing an oxygen absorbent in a sheet form arranged, as a filling sheet between each edge of a tire structural material and an inner liner.

7. A pneumatic tire as claimed in claim 6, wherein said sheet of rubber or thermoplastic resin composition is arranged between an inner liner of a shoulder and a carcass, between a carcass and a carcass, or between a carcass and a belt.
